(19) United States
(12) Patent Application Publication
(10) Pub. No.: US 2021/0158220 A1
(43) Pub. Date: May 27, 2021

(54) OPTIMIZING ACCURACY OF MACHINE LEARNING ALGORITHMS FOR MONITORING INDUSTRIAL MACHINE OPERATION

(71) Applicant: SKF AI, Ltd., Yoqneam (IL)

(72) Inventors: David LAVID BEN LULU, Nesher (IL); Waseem GHRAYEB, Nazareth Illit (IL)

(21) Appl. No.: 17/165,432

(22) Filed: Feb. 2, 2021

Related U.S. Application Data
(63) Continuation of application No. PCT/US2019/046120, filed on Aug. 12, 2019.
(60) Provisional application No. 62/717,855, filed on Aug. 12, 2018.

(51) Int. Cl. G06N 20/00; G06N 5/04

(52) U.S. Cl. CPC G06N 20/00; G06N 5/04

(57) ABSTRACT

A system and method for a method for optimizing machine learning algorithms for monitoring industrial machine operation, including: monitoring at least one industrial machine behavioral model of at least one industrial machine; identifying at least a first ambiguous segment of the at least one industrial machine behavioral model having a first set of characteristics, and identifying a corrective solution recommendation associated with the first ambiguous segment; identifying at least a second ambiguous segment of the at least one industrial machine behavioral model having a second set of characteristics; determining if a similarity between the first set of characteristics and the second set of characteristics exceed a predetermined threshold; and updating a machine learning algorithm of the at least one industrial machine behavioral model to associate the corrective solution recommendation to the second ambiguous segment when it is determined that the similarity has exceed the predetermined threshold.

### CROSS-REFERENCE TO RELATED APPLICATIONS

This application is a continuation of International Application No. PCT/US2019/046120, filed Aug. 12, 2019, which claims the benefit of U.S. Provisional Application No. 62/717,855 filed on Aug. 12, 2018, the contents of which are hereby incorporated by reference.

### TECHNICAL FIELD

The present disclosure relates generally to maintenance systems for machines, and more specifically to monitoring machine operations for improving machine processes.

### BACKGROUND

Communications, processing, cloud computing, artificial intelligence, and other computerized technologies have advanced significantly in recent years, heralding in new fields of technology and production. Further, many of the industrial technologies employed since or before the 1970s are still in use today. Existing solutions related to these industrial technologies have often seen only minor improvements, merely increasing production and yield slightly.

In modern manufacturing practices, manufacturers must often meet strict production timelines and provide flawless or nearly flawless production quality. As a result, these manufacturers risk heavy losses whenever an unexpected machine failure occurs. A machine failure is an event that occurs when a machine deviates from correct service. Errors, which are typically deviations from the correct state of the machine, are not necessarily failures, but may lead to and indicate potential future failures. Besides failures, errors may otherwise cause unusual machine behavior that may affect performance.

The average failure-based machine downtime for typical manufacturers (i.e., the average amount of time in which production is shuts down, either in part or in whole, due to a machine failure) is 17 days per year, i.e., 17 days of lost production and, hence revenue. In the case of a typical 450 megawatt power turbine, for example, a single day of downtime can cost a manufacturer over $3 million US in lost revenue. Such downtime may have additional costs related to repair, safety precautions, and the like.

In energy power plants, billions of US dollars are spent annually on ensuring reliability. Specifically, billions of dollars are spent on backup systems and redundancies utilized to minimize production downtimes. Additionally, monitoring systems may be utilized to identify failures quickly, thereby speeding up a return to production when downtime occurs. However, existing monitoring systems typically identify failures only after or immediately before downtime begins.

Further, existing solutions for monitoring machine failures typically rely on a set of predetermined rules for each machine. These rules sets do not account for all data that may be collected with respect to the machine, and are only used for checking particular key parameters while ignoring the rest. Moreover, these rule sets must be provided in advance by engineers or other human analysts. As a result, only some of the collected data may be actually used by existing solutions, thereby resulting in wasted use of computing resources related to the transmission, storage, and processing of unused data. Further, failure to consider all relevant data may result in missed or otherwise inaccurate determination or prediction of failures.

Additionally, existing solutions often rely on periodic testing at predetermined intervals. Thus, even existing solutions that can predict failures in advance typically return requests to perform machine maintenance even when the machine is not in immediate condition of failure. Such premature replacement and maintenance results in wasted materials and expenses spent replacing parts that are still functioning properly. Further, such existing solutions often result in initiating repairs only after failure occurs. As a result, failures may not be prevented, resulting in down time and lost revenue.

Furthermore, existing monitoring and maintenance solutions often require dedicated testing equipment. Consequently, these solutions typically require specialized operators who are well-trained in the operation of each monitoring and maintenance system. Requiring specialized operators can be inconvenient and costly, and may introduce potential sources of human error. Additionally, given the sheer amount of data that may be collected for any given machine in addition to minute fluctuations in data, a human analyst is not capable of adequately determining upcoming failures.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for optimizing machine learning algorithms for monitoring industrial machine operation, including: monitoring at least one industrial machine behavioral model of at least one industrial machine; identifying at least a first ambiguous segment of the at least one industrial machine behavioral model having a first set of characteristics, and identifying a corrective solution recommendation associated with the first ambiguous segment; identifying at least a second ambiguous segment of the at least one industrial machine behavioral model having a second set of characteristics; determining if a similarity between the first set of characteristics and the second set of characteristics exceed a predetermined threshold; and updating a machine learning algorithm of the at least one industrial machine behavioral model to associate the corrective solution recommendation to the second ambiguous segment when it is determined that the similarity has exceed the predetermined threshold.

Certain embodiments disclosed herein also include a non-transitory computer readable medium having stored thereon instructions for causing a processing circuitry to perform a process, the process including: monitoring at least one industrial machine behavioral model of at least one industrial machine; identifying at least a first ambiguous segment of the at least one industrial machine behavioral model having a first set of characteristics, and identifying a corrective solution recommendation associated with the first ambiguous segment; identifying at least a second ambiguous segment of the at least one industrial machine behavioral model having a second set of characteristics; determining if a similarity between the first set of characteristics and the second set of characteristics exceed a predetermined threshold; and updating a machine learning algorithm of the at least one industrial machine behavioral model to associate the corrective solution recommendation to the second ambiguous segment when it is determined that the similarity has exceed the predetermined threshold.

Certain embodiments disclosed herein also include a system for optimizing machine learning algorithms for monitoring industrial machine operation, including: a processing circuitry; and a memory, the memory containing instructions that, when executed by the processing circuitry, configure the system to: monitor at least one industrial machine behavioral model of at least one industrial machine; identify at least a first ambiguous segment of the at least one industrial machine behavioral model having a first set of characteristics, and identifying a corrective solution recommendation associated with the first ambiguous segment; identify at least a second ambiguous segment of the at least one industrial machine behavioral model having a second set of characteristics; determine if a similarity between the first set of characteristics and the second set of characteristics exceed a predetermined threshold; and update a machine learning algorithm of the at least one industrial machine behavioral model to associate the corrective solution recommendation to the second ambiguous segment when it is determined that the similarity has exceed the predetermined threshold.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of the management server system according to an embodiment.

FIG. 3 is a flowchart illustrating a method for enhancing accuracy level of a machine learning algorithm adapted to monitor machine operation according to an embodiment.

FIG. 4 is a flowchart illustrating a reinforcement learning based method for automatically providing corrective solution recommendations for a machine operation according to an embodiment.

FIG. 5 is a flowchart illustrating a reinforcement learning based method for updating a machine learning algorithm adapted to monitor machine operation according to an embodiment.

FIG. 6 is an example simulation illustrating representation of an ambiguous segment in a machine behavioral model according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed reinforcement learning based method is utilized to identify ambiguous segments in a machine behavioral model of a machine to be used for optimizing a machine learning algorithm for monitoring industrial machine operation. The machine behavioral model is based on sensory inputs received from one or more sensors of the machine. In response to identification of such ambiguous segment, a query is generated and sent to a client device. A response, i.e. an input, is then received with respect to the query, the response is utilized to update a machine learning algorithm that is adapted to monitor the machine operation, and specifically predict in time a forthcoming machine failure. In a further embodiment, a first ambiguous segment is identified and compared to a second ambiguous segment. If the two segments are determined to be similar above a predetermined threshold, a corrective recommendation for the first segment is determined to be suitable for the second ambiguous segment.

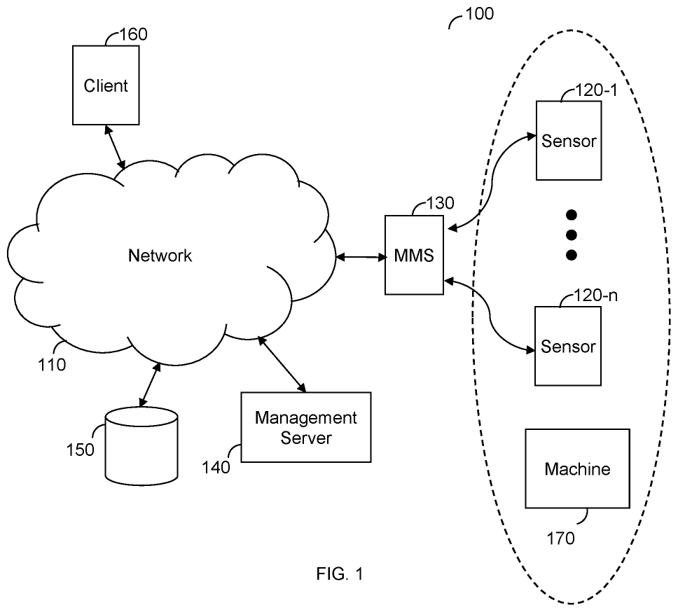

FIG. 1 shows an example network diagram 100 utilized to describe the various disclosed embodiments. The example network diagram 100 includes a machine monitoring system (MMS) 130, a management server 140, a database 150, and a client device 160 connected through a network 110. The example network diagram 100 further includes a plurality of sensors 120-1 through 120-n (hereinafter referred to individually as a sensor 120 and collectively as sensors 120, merely for simplicity purposes, where n is an integer equal to or greater than 1), connected to the machine monitoring system 130. The network 110 may be, but is not limited to, a wireless network, a cellular or wired network, a local area network (LAN), a wide area network (WAN), a metro area network (MAN), the Internet, the worldwide web (WWW), similar networks, and any combination thereof.

The client device 160 may be, but is not limited to, a personal computer, a laptop, a tablet computer, a smartphone, a wearable computing device, a log, a data source (e.g. database), or any other device capable of receiving and/or displaying notifications indicating maintenance and failure timing predictions, results of supervised analysis, unsupervised analysis of machine operation data, and the like.

The sensors 120 are located in proximity (e.g., physical proximity) to a machine 170. The machine 170 may be any machine for which performance can be represented via sensory data including an industrial machine used in industrial settings, but not limited to, a turbine, an engine, a welding machine, a three-dimensional (3D) printer, an injection molding machine, a combination thereof, a portion thereof, and the like. Each sensor 120 is configured to collect sensory inputs such as, but not limited to, sound signals, ultrasound signals, light, movement tracking indicators, temperature, energy consumption indicators, and the like based on operation of the machine 170. The sensors 120 may include, but are not limited to, sound capturing sensors, motion tracking sensors, energy consumption meters, temperature meters, and the like. Any of the sensors 120 may be, but are not necessarily, communicatively or otherwise connected to the machine 170 (such connection is not illustrated in FIG. 1 merely for the sake of simplicity and without limitation on the disclosed embodiments).

The sensors 120 are connected to the machine monitoring system 130. The machine monitoring system 130 may be configured to store and preprocess raw sensory inputs received from the sensors 120. Alternatively, or collectively, the machine monitoring system 130 may be configured to periodically retrieve collected sensory inputs stored in, for example, the database 150. The preprocessing may include, but is not limited to, data cleansing, normalization, rescaling, re-trending, reformatting, noise filtering, a combination thereof, and the like.

The management server 140, typically including at least a processing circuitry (not shown) and a memory (not shown), the memory contains therein instructions that when executed by the processing circuitry configures the management server 140 as further described herein below. According to an embodiment of the disclosure, the instructions stored in the memory are those that configure the system 100 to perform the method described herein below. The memory may contain also data collected by the sensors 120, however, such data may also be stored in a data warehouse such as a database 150, where in certain embodiments the memory of the management server 140 stores into or retrieves therefrom data and/or instructions.

In an embodiment, the management server 140 is configured to monitor at least a first machine behavioral model of a machine (e.g., the machine 170). The machine behavioral model may be represented by, for example, a graph aggregating a plurality of sensory inputs that are associated with a plurality of components of a machine and/or processes executed by a machine (e.g., the machine 170). In a further embodiment, the machine behavioral model may be represented by meta-models, where each meta-model is associated with a component of the machine. The meta-models are based on the indicative sensory inputs related to their respective components and may be utilized to identify anomalies in the operation of each respective component of the machine. In a further embodiment, the first machine behavioral model may be divided to a plurality of segments. The segments may be determined by time frames, starting point and ending point of at least an abnormal operational behavior of at least a component of the machine represented by the graph, and so on.

In an embodiment, the management server 140 is configured to identify at least a first ambiguous segment in the at least a first machine behavioral model. An ambiguous segment may include characteristics that, for example, were not identified, determined or analyzed in previous segments of the same machine or in similar machines. The ambiguous segment may represent abnormal behavior of at least a component of the machine. The ambiguous segment may include, for example, exceeding a new threshold that has never been exceeded before, new behavioral patterns that never occurred before, and the like.

In an embodiment, the management server 140 is configured to generate, based on the identification of the at least a first ambiguous segment, at least one notification. The at least one notification comprises at least a query that may be generated responsive to the identification of at least a portion of the ambiguous segment. The query may include at least a question that a response thereto may allow to identify a root cause for the formation of the unusual characteristics, or parameters, of the first ambiguous segment. The root cause may be undesirable circumstances, such as an accumulation of gases within a certain component of a machine (e.g., the machine 170). In a further embodiment, the query may include at least a question that a response thereto may narrow down the options for the formation of the unusual characteristics, or parameters, of the first ambiguous segment. The management server 140 may configured to send the notification to at least a client device (e.g. the client device 160).

In an embodiment, the management server 140 is configured to monitor at least a portion of a first machine behavioral model related to at least one machine (e.g. the machine 170). In a further embodiment, the monitoring enables generation of a plurality of analytics associated with the operation of the at least one machine or a component of the machine, for example, anomalies, trends, energy consumption parameters, expected maintenance requirements, and the like. The behavioral model consists of sensory inputs received from a plurality of sensors (e.g. the sensors 120) of a machine (e.g. the machine 170).

The behavioral model may indicate at least a normal behavior of the machine, an abnormal behavior of the machine, a trend that indicates on a forthcoming machine failure, an ambiguous behavior of the machine, and the like. An ambiguous behavior may be represented by parameters, values, sequences, and the like, associated with at least a component of a machine (e.g. the machine 170), that the management server 140 is unable to classify nor determine their meaning or influence. The first machine behavioral model may include a plurality of segments. Each segment may be distinguished from other segments in terms of, for example, time intervals, change in the graph of the first machine behavioral model indicating on an increasing values or reduced value above or below a certain threshold, and the like.

In an embodiment, the management server 140 is configured to identify at least a first ambiguous segment in the at least a first machine behavioral model. The ambiguous segment may be represented by parameters, values, sequences, and the like, associated with at least a component of a machine (e.g. the machine 170), that the management server 140 is unable to classify nor determine their meaning or influence on the machine. The ambiguous segment represents an unclear behavior of at least a component of the machine 170. For example, an ambiguous segment of the first machine behavioral model may include a parameter value that is considered as a relatively high when compared to average values of that parameter. An ambiguous segment may indicate, for example, down time, a failure related to one or more of the machine's components, and the like, that may not be determined above a certainty level. The certainty level may be related to the existence of an ambiguous event or to a time frame at which the ambiguous event has occurred. For example, the management server 140 may be configured to determine that a down time has occurred, however the accurate time frame of the downtime may be ambiguous to the management server 140. The identification of at that at least a first ambiguous segment may be achieved using at least one machine learning model.

In an embodiment, the management server 140 is configured to generate, based on the identification of the first ambiguous segment, at least one notification that includes at least a query. In a further embodiment, the management server 140 sends the notification to at least a client device (e.g. the client device 160). In a further embodiment, the notification may be sent to a log, a database, and the like. The notification may be an electronic message sent through electronic mail (email), short message service (SMS), and the like. The query may include textual and/or vocal elements. As an example, a query may include open or closed question, such as but not limited to, “Has a downtime occurred?”, “What are the symptoms?”, and “What is the solution?”. The query may be generated with respect to the ambiguous segment values. For example, after receiving a sequence of relatively low values of the first machine behavioral model, the management server 140 may generate a query that is related to the abovementioned sequence. According to the same example, the query may be: “Has a downtime occurred?”

In an embodiment, the management server 140 is configured to receive at least one input from a client device (e.g. the client device 160) responsive of the query. The input may be for example a user feedback and may be entered by a user using a client device (e.g. the client device 160). In a further embodiment, the input may be received from a log, a database, and the like. In a further embodiment, the input may include a corrective solution recommendation, an answer to a closed or open question, root cause description, confirmation of the machine learning algorithm estimation regarding the ambiguous segment (the estimation may be related to detection and/or prediction of one or more machine failures), and so on. The input may include for example, a word, a sentence, a number, a portion thereof, a combination thereof, and so on. The input may be for example and without limitations, “Yes”, “No”, “increase in pressure gauges”, “open the pressure valves”, and the like. As an example, a query, such as “Has a downtime occurred?”, is sent to a client device and displayed on a display unit (not shown) of a client device. Thereafter, the user feedback to the query, such as “Yes” or “No” is received at the management server 140. It should be noted that there may be multiple and/or sequence of queries and inputs related to the queries.

In an embodiment, the management server 140 is configured to update, based on the received input, a machine learning algorithm such as a deep learning model that is adapted to, for example, detect abnormal behaviors in a plurality of machine behavioral models, identify patterns and/or trends that may indicate on forthcoming machine failures, and the like. In an embodiment, the received input is used to adjust a deep learning reward function, causing continuous improvement in the machine learning accuracy based on the received input.

It should be noted that when no input is received from the client device 160, the management server 140 is configured to generate one or more corrective solution recommendations with respect to the identified ambiguous segment by, for example, comparing the characteristics of the ambiguous segment to one or more previous segments of one or more machine behavioral models that were previously analyzed and determined. According to the same example, the comparison allows to identify a high level of similarity between the characteristics of the ambiguous segment and the previous segments such that one or more corrective solution recommendations that were previously associated with the previous segments may be also associated with the ambiguous segment.

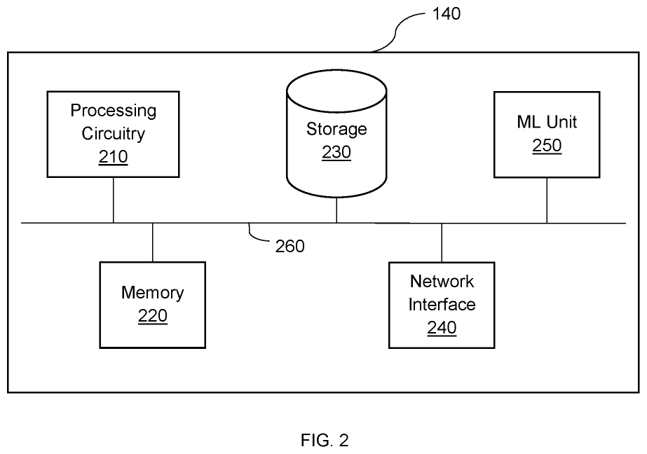

FIG. 2 shows an example block diagram of the management server 140 implemented according to an embodiment. The management server 140 includes a processing circuitry 210 coupled to a memory 220, a storage 230, a network interface 240, and a machine learning (ML) unit 250. In an embodiment, the components of the machine failure predictor 140 are connected through a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 220 may be volatile (e.g., RAM), non-volatile (e.g., ROM or flash memory), or a combination thereof. In one configuration, computer readable instructions to implement one or more embodiments disclosed herein may be stored in the storage 230.

In an embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the management server 140 to communicate with the machine monitoring system 130, e.g., via the network 110, for the purpose of, for example, receiving raw and/or preprocessed sensory inputs. Additionally, the network interface 240 allows the management server 140 to communicate with the client device 160 in order to send inputs, receive inputs, and so on.

The machine learning unit 250 is configured to perform machine learning based on sensory inputs received via the network interface 240 as described further herein. In an embodiment, the machine learning unit 250 is further configured to identify ambiguous segments in a machine behavioral model of a machine as further described herein above. In an embodiment, the machine learning unit 250 is further configured to apply a deep learning model that is used to estimate a reward function, i.e., an input received from a client device. In an embodiment, the machine learning unit 250 is further configured to determine, based on one or more machine learning models, predictions for failures of the machine 170. In a further embodiment, the machine learning unit 250 is also configured to determine at least one recommendation, such as a corrective solution recommendation, for avoiding or mitigating the determined predicted failures. As an example, the at least one recommendation may indicate that an exhaust pipe on the machine 170 should be replaced in the near future with a new exhaust pipe to avoid failure.

It should be understood that the embodiments described herein are not limited to the specific architecture illustrated in FIG. 2, and other architectures may be equally used without departing from the scope of the disclosed embodiments.

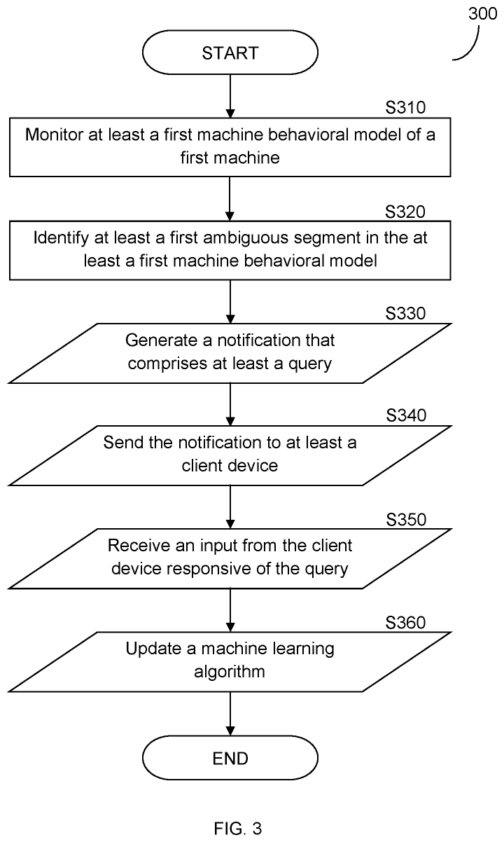

FIG. 3 is an example flowchart 300 illustrating a method for enhancing the accuracy level of a machine learning algorithm adapted to monitor machine operation according to an embodiment. In an embodiment, the method may be performed by a management server, e.g., the management server 140 of FIG. 1.

At S310, at least a first machine behavioral model of a first machine is monitored, e.g., by a management server. The monitoring enables generation of a plurality of analytics associated with the operation of the at least one machine or a component of the machine. The analytics may include anomalies, trends, energy consumption parameters, expected maintenance requirements, and the like.

At S320, at least a first ambiguous segment is identified in the first machine behavioral model. The ambiguous segment represents an unclear behavior of at least a component of the machine represented by parameters, values, sequences, and the like, that is unable to be classified, e.g., by the machine, or determined as to their meaning or influence on the machine.

At S330, at least one notification that includes at least a query is generated based on the identification of the first ambiguous segment. The notification may be customized to be send to a specific client device (e.g. the client device 160).

At S340, the notification is sent to a client device (e.g. the client device 160). The notification may be in the form of an electronic message sent through electronic mail (email), short messaging service (SMS), multimedia messaging server (MMS), internet-based messaging service, and the like.

At S350, at least one input is received from a client device (e.g. the client device 160) responsive to the query. The input may be, for example, direct user feedback and may be entered by a user using the client device.

At S360, a machine learning algorithm is updated based on the at least one input. The machine learning algorithm may be, for example, a deep learning model that is adapted to detect abnormal behaviors in a plurality of machine behavioral models, identify patterns and/or trends that may indicate on forthcoming machine failures, and the like associated with one or more machines.

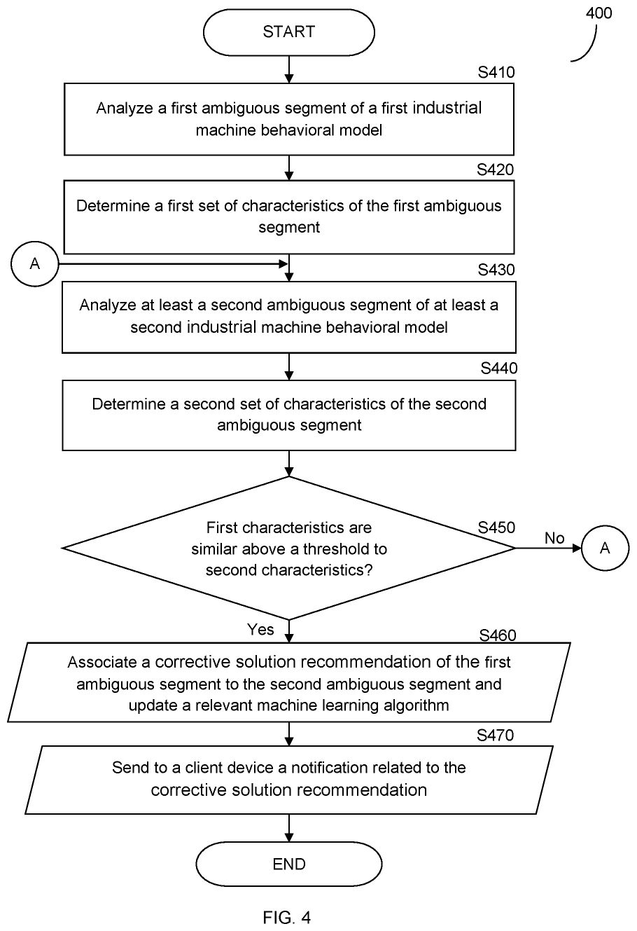

FIG. 4 is an example flowchart 400 illustrating a reinforcement learning based method for automatically providing corrective solution recommendations for a machine operation according to an embodiment.

At S410, a first industrial machine behavioral model that is associated with a first industrial machine (e.g. the machine 170) is monitored to identify and analyze a first ambiguous segment. An industrial machine behavioral model may be represented by, for example, a graph aggregating a plurality of sensory inputs that are associated with a plurality of components of the first industrial machine and/or processes executed by the first industrial machine. The first ambiguous segment may include characteristics that have not been analyzed in previous segments of the same industrial machine behavioral model or in similar types of industrial machine behavioral models having similar characteristics. The first ambiguous segment may include, for example, exceeding a predetermined threshold that has not exceeded before, new parameters sequence that never occurred before, and the like. The analysis of the first ambiguous segment may include extraction of one or more characteristics associated with the first ambiguous segment such as parameters received from sensory inputs using the machine sensors of at least a component of the industrial machine at time of the ambiguous segment.

At S420, a first set of characteristics related to the first ambiguous segment is determined. The first set of characteristics are parameters of at least a component of the first industrial machine at a specific point in time, e.g., when an ambiguous segment indicating an unfamiliar behavior of at least a component of the first industrial machine has been detected. Examples of such behavior may include crossing a predetermined threshold of one of: an operating temperature, a speed of revolution of a component of the industrial machine, various parameters measuring productivity of the industrial machine, and the like.

At S430, a second ambiguous segment of a second industrial machine behavioral model, that may be associated with the first industrial machine or with a second industrial machine, is monitored to identify and analyze a second ambiguous segment. A machine behavioral model may be represented by, for example, a graph aggregating a plurality of sensory inputs that are associated with a plurality of components of the first industrial machine and/or processes executed by the first industrial machine. The second ambiguous segment may include characteristics that have not been analyzed in previous segments of the same industrial machine behavioral model or in similar types of industrial machine behavioral models having similar characteristics. The analysis of the second ambiguous segment may include extraction of one or more characteristics associated with the second ambiguous segment such as parameters received from sensory inputs using sensors of at least a component of an industrial machine at time of the second ambiguous segment.

At S440, a second set of characteristics related to the second ambiguous segment is determined. The second set of characteristics are parameters of at least a component of an industrial machine at a specific point in time, e.g., when an ambiguous segment indicating an unfamiliar behavior of at least a component of the industrial machine has been detected. Examples of such behavior may include crossing a predetermined threshold of one of: an operating temperature, a speed of revolution of a component of the industrial machine, various parameters measuring productivity of the industrial machine, and the like.

At S450, it is determined whether the first set of characteristics is similar above a predetermined threshold to the second set of characteristics, and if so execution continues with S460; otherwise, execution continues with S430. The threshold is used to distinguish similar ambiguous segments from dissimilar ambiguous segments. For example, similarity between two sets of characteristics of a first and a second ambiguous segments may include similar sensory inputs values, similar starting points of the ambiguous segment, time frames, and the like. In an embodiment, the determination of the similarity may be achieved using one or more machine learning methods, a deep learning method, and/or a statistical approach. In an embodiment, the determination may be achieved using a similarity function, which is a function that provides a quantitative value representing the similarity between the two sets of characteristics.

At S460, at least a recommendation, such as a corrective solution recommendation, that was previously determined with respect to the first ambiguous segment is associated with the second ambiguous segment. The corrective solution recommendation may be retrieved from, for example, a database. In an embodiment, the previously determined recommendation may be previously received as an input from a client device (e.g. the client device 160) upon sending a notification that includes a query with respect to the first ambiguous segment, to the client device and receiving a user feedback to the first ambiguous segment. In an embodiment, after the recommendation is received, the recommendation is stored in, for example, a database and may be associated with the first set of characteristics of the ambiguous segment to which the recommendation relates. In a further embodiment, machine learning algorithm of the at least one industrial machine behavioral model is updated to associate the corrective solution recommendation to the second ambiguous segment.

At optional S470, a notification related to the corrective solution recommendation is sent to a client device. The recommendation, determined to be suitable for the second ambiguous segment based on the similar characteristics, may be offered to a user to perform changes in the machine operation such that, for example, a machine failure may be prevented. In a further embodiment, S470 may further include performing an adjustment of the recommendation based on, for example, the machine type, machine characteristics, the second set of characteristics of the at least a second segment, and the like.

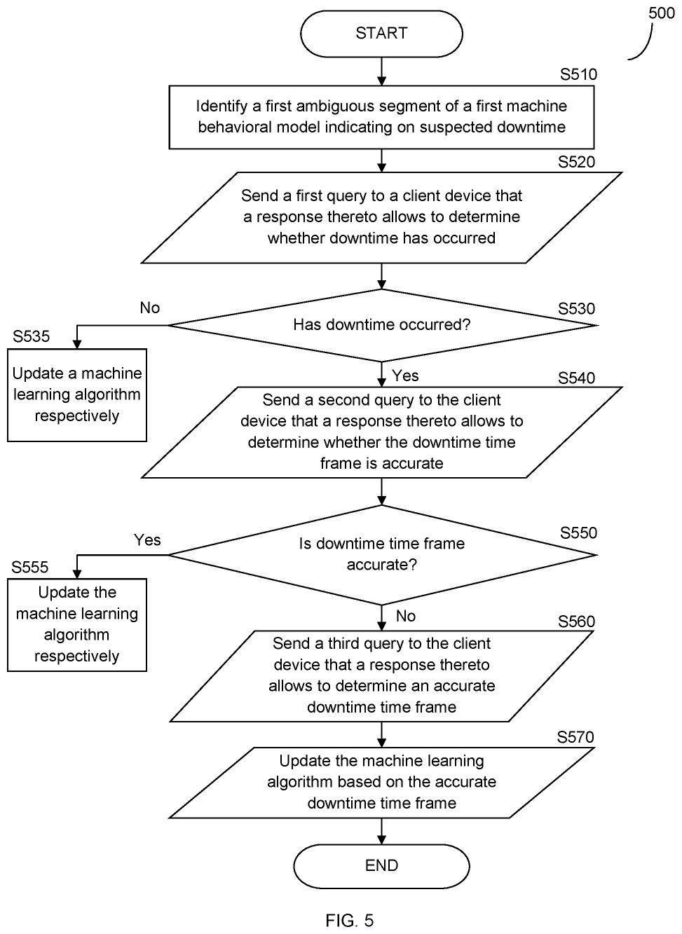

FIG. 5 is an example flowchart 500 illustrating a reinforcement learning based method for updating a machine learning algorithm adapted to monitor machine operation according to an embodiment.

At S510, a first ambiguous segment of a first machine behavioral model that indicates a suspected downtime is identified. The suspected downtime may be identified based on ambiguous parameters of sensory inputs received from one or more sensors of the machine. Ambiguous parameters may be represented by unusual parameters that their meaning, i.e., their influence on the machine operation, has not been determined.

At S520, a first query that a response thereto allows to determine whether a downtime has occurred is sent to a client device (e.g. the client device 160). In an embodiment, S520 further includes generation of the first query with respect to, for example, the first ambiguous segment characteristics.

At S530, it is determined whether a downtime occurred based on a response received from the client device and if so execution continues with S540; otherwise, execution continues with S535. In an embodiment, S530 further includes analyzing a first input, e.g. a user response, using one or more machine learning techniques, for determining whether a downtime has occurred.

At S535, when it is determined that a downtime has not occurred, the machine learning algorithm adapted to monitor the machine operation, and specifically to predict machine failures, is updated. The update may be achieved using the first input received from the client device with respect to the first query.

At S540, a second query that a response thereto allows to determine whether the downtime time frame is accurate is sent to a client device (e.g. the client device 160). In an embodiment, S540 further includes generation of the second query with respect to receiving a positive user response to the first query.

At S550, it is determined whether a downtime time frame is accurate as identified by the management server 140 and if so execution continues with S555; otherwise, execution continues with S560. The determination may be achieved based on a second input, e.g. a response, received from a client device (e.g. the client device 160) to the second query. In an embodiment, S550 further includes analyzing the response, e.g. user feedback, using one or more machine learning techniques, for determining whether the downtime time frame as initially determined by the management server 140 is accurate.

At S555, when it is determined that the downtime timeframe is accurate, the machine learning algorithm adapted to monitor the machine operation, and specifically to predict machine failures, is updated. The update may be achieved using a second input received from the client device with respect to the second query.

At S560, a third query that a response thereto allows to determine an accurate downtime time frame is sent to a client device (e.g., the client device 160). In an embodiment, S560 further includes generation of the third query with respect to receiving a negative user response to the second query.

At S570, upon receiving a third input from the client device with respect to the third query, the management server 140 updates the machine learning algorithm based on the accurate downtime time frame received indicated at the third input.

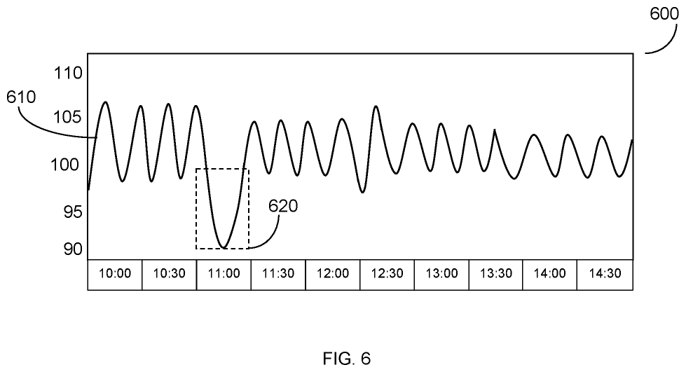

FIG. 6 is an example simulation illustrating representation of an ambiguous segment in a machine behavioral model according to an embodiment. The simulation shown in FIG. 6 includes a graph 610 that represents a machine behavioral model as received from one or more sensors of the monitored machine. By analyzing the graph 610, ambiguous segments such as the segment 620 may be identified. An ambiguous segment may include characteristics that, for example, were not identified, determined or analyzed in previous segments of the same machine or in similar machines. The ambiguous segment may include, for example, exceeding a new threshold that has never exceeded before, new parameters sequence that never occurred before, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for optimizing machine learning algorithms for monitoring industrial machine operation, comprising:
monitoring at least one industrial machine behavioral model of at least one industrial machine;
identifying at least a first ambiguous segment of the at least one industrial machine behavioral model having a first set of characteristics, and identifying a corrective solution recommendation associated with the first ambiguous segment;
identifying at least a second ambiguous segment of the at least one industrial machine behavioral model having a second set of characteristics;
determining if a similarity between the first set of characteristics and the second set of characteristics exceed a predetermined threshold; and
updating a machine learning algorithm of the at least one industrial machine behavioral model to associate the corrective solution recommendation to the second ambiguous segment when it is determined that the similarity has exceed the predetermined threshold.

2. The method of claim 1, further comprising:
generating a notification related to the corrective solution recommendation for the second ambiguous segment; and
sending the notification to a client device.

3. The method of claim 1, wherein the first ambiguous segment indicates a suspected downtime of the at least one industrial machine.

4. The method of claim 1, wherein determining that the similarity has exceed the predetermined threshold is achieved using at least one of: a machine learning method, a deep learning model, a statistical approach, and a similarity function.

5. The method of claim 1, further comprising:
sending a first query to a client device with respect to the first ambiguous segment to determine if a detected downtime as occurred; and
determining if a downtime has occurred based on a response to the first query.

6. The method of claim 5, further comprising:
updating the machine learning algorithm when it is determined that no downtime has occurred.

7. The method of claim 5, further comprising:
sending a second query to a client device to determine if a time frame of the downtime is accurate when it is determined that downtime has occurred; and
determining if the downtime time frame is accurate based on a response to the second query.

8. The method of claim 7, further comprising:
updating the machine learning algorithm when it is determined that the downtime time frame is accurate.

9. The method of claim 7, further comprising:
sending a third query to a client device to determine an updated time frame of the downtime when it is determined that that downtime time frame is not accurate; and
updating the machine learning algorithm with the updated time frame.

10. A non-transitory computer readable medium having stored thereon instructions for causing a processing circuitry to perform a process, the process comprising:
monitoring at least one industrial machine behavioral model of at least one industrial machine;
identifying at least a first ambiguous segment of the at least one industrial machine behavioral model having a first set of characteristics, and identifying a corrective solution recommendation associated with the first ambiguous segment;
identifying at least a second ambiguous segment of the at least one industrial machine behavioral model having a second set of characteristics;
determining if a similarity between the first set of characteristics and the second set of characteristics exceed a predetermined threshold; and
updating a machine learning algorithm of the at least one industrial machine behavioral model to associate the corrective solution recommendation to the second ambiguous segment when it is determined that the similarity has exceed the predetermined threshold;

11. A system for optimizing machine learning algorithms for monitoring industrial machine operation, comprising:
a processing circuitry; and
a memory, the memory containing instructions that, when executed by the processing circuitry, configure the system to:
monitor at least one industrial machine behavioral model of at least one industrial machine;
identify at least a first ambiguous segment of the at least one industrial machine behavioral model having a first set of characteristics, and identifying a corrective solution recommendation associated with the first ambiguous segment;
identify at least a second ambiguous segment of the at least one industrial machine behavioral model having a second set of characteristics;
determine if a similarity between the first set of characteristics and the second set of characteristics exceed a predetermined threshold; and
update a machine learning algorithm of the at least one industrial machine behavioral model to associate the corrective solution recommendation to the second ambiguous segment when it is determined that the similarity has exceed the predetermined threshold.

12. The system of claim 11, wherein the system is further configured to:
generate a notification related to the corrective solution recommendation for the second ambiguous segment; and
send the notification to a client device.

13. The system of claim 11, wherein the first ambiguous segment indicates a suspected downtime of the at least one industrial machine.

14. The system of claim 11, wherein determining that the similarity has exceed the predetermined threshold is achieved using at least one of: a machine learning method, a deep learning model, a statistical approach, and a similarity function.

15. The system of claim 11, wherein the system is further configured to:
send a first query to a client device with respect to the first ambiguous segment to determine if a detected downtime as occurred; and
determine if a downtime has occurred based on a response to the first query.

16. The system of claim 15, wherein the system is further configured to:
update the machine learning algorithm when it is determined that no downtime has occurred.

17. The system of claim 15, wherein the system is further configured to:
send a second query to a client device to determine if a time frame of the downtime is accurate when it is determined that downtime has occurred; and
determine if the downtime time frame is accurate based on a response to the second query.

18. The system of claim 17, wherein the system is further configured to:
update the machine learning algorithm when it is determined that the downtime time frame is accurate.

19. The system of claim 17, wherein the system is further configured to:
send a third query to a client device to determine an updated time frame of the downtime when it is determined that that downtime time frame is not accurate; and
update the machine learning algorithm with the updated time frame.
